(19) United States
(12) Patent Application Publication
(10) Pub. No.: US 2024/0029538 A1
(43) Pub. Date: Jan. 25, 2024

(54) VOICE CONFERENCE AUDIO DATA VIA PROCESS IDENTIFIERS

(71) Applicant: Hewlett-Packard Development Company, L.P., Spring, TX (US)

(72) Inventors: Edward Yenting Kuo, Taipei City (TW); Li Jen Lee, Taipei City (TW); Hsiang Ta Ke, Taipei City (TW)

(21) Appl. No.: 18/256,543

(22) PCT Filed: Dec. 10, 2020
(86) PCT No.: PCT/US2020/064339

§ 371 Date: Jun. 8, 2023

(51) Int. Cl. G08B 21/18; H04M 3/56; G10L 15/08

(52) U.S. Cl. CPC G08B 21/18; H04M 3/56; G10L 15/08; G10L 2015/088

(57) ABSTRACT

In Example systems and methods for monitoring voice conferencing sessions are disclosed. In an example, the system includes a memory and a processor communicatively coupled to the memory. The processor is to identify a process identifier (ID) assigned to a voice conferencing session executed on the electronic device. In addition, the processor is to identify an audio thread using the process ID, the audio thread including audio data for the voice conferencing session. Further, the processor is to identify an audio thread ID of the audio thread. Still further, the processor is to use the audio thread ID to compare the audio data to a keyword to identify a match, and generate a notification for a user of the electronic device in response to the match.

### BACKGROUND

The advancement of global communications has allowed groups of individuals (e.g., co-workers, classmates, social club members, etc.) to interact with one another via electronic methods. In particular, voice conferencing applications executed on electronic devices, such as computers, smartphones, etc., allow real-time communications between groups of remotely located individuals. In many professional settings, a large number of group meetings may be conducted using such voice conferencing applications.

### BRIEF DESCRIPTION OF THE DRAWINGS

Various examples will be described below referring to the following figures:

FIG. 1 is a schematic diagram of an electronic device to monitor voice conference sessions executed thereon according to some examples;

FIG. 2 is a schematic diagram of processes executed on a processor of an electronic device according to some examples;

FIG. 3 is a flow chart of machine-readable instructions for monitoring voice conferencing sessions executed on an electronic device according to some examples;

FIG. 4 is a flow chart of machine-readable instructions for monitoring voice conferencing sessions executed on an electronic device according to some examples; and

FIG. 5 is a flow chart of a method for monitoring voice conferencing sessions executed on an electronic device according to some examples.

### DETAILED DESCRIPTION

Voice conferencing applications (or more simply “conferencing applications”) allow a plurality of individuals to conduct real-time voice conferencing sessions via electronic devices. Voice conferencing sessions may comprise audio or audio-visual data streams that are directed to and from the plurality of individuals to facilitate real-time conversation. More particularly, a voice conferencing session may comprise a voice call (e.g., such as those conducted over a voice over internet protocol (VOIP) system), a video conference, etc. An electronic device for executing a voice conferencing session may include any suitable device that may execute machine-readable instructions. In some examples, an electronic device for executing a voice conferencing session may comprise, for instance, a computer (e.g., desktop computer, laptop computer, all-in-one computer), a smartphone, etc.

In some circumstances, a user of an electronic device may wish to multi-task while participating in a voice conferencing session. For instance, a user may wish to perform another task during the voice conferencing session, or may even wish to participate in multiple voice conferencing sessions simultaneously. In either case, the user may not actively listen for the entire duration of the voice conference session(s), and may therefore fail to answer a question, provide requested input in a timely manner, or otherwise miss cues for response or feedback.

Accordingly, examples disclosed herein provide systems and methods for monitoring the content of one (or a plurality of) voice conferencing sessions being executed on an electronic device, and for cuing the user when a response is requested or appropriate. In some examples, the systems and methods may comprise machine-readable instructions that are stored and executed on the user's electronic device (which may be referred to as the “client device”). This arrangement may be distinct from situations where machine-readable instructions are stored and/or executed on a server or other electronic device operated by the voice conferencing service that is hosting the voice conferencing session. As a result, the systems and methods may operate independently of the conferencing application itself and may be utilized to monitor voice conferences provided by different voice conference applications being executed on the electronic device. Thus, through use of the example systems and methods described herein, a user may more effectively multi-task during a voice conferencing session.

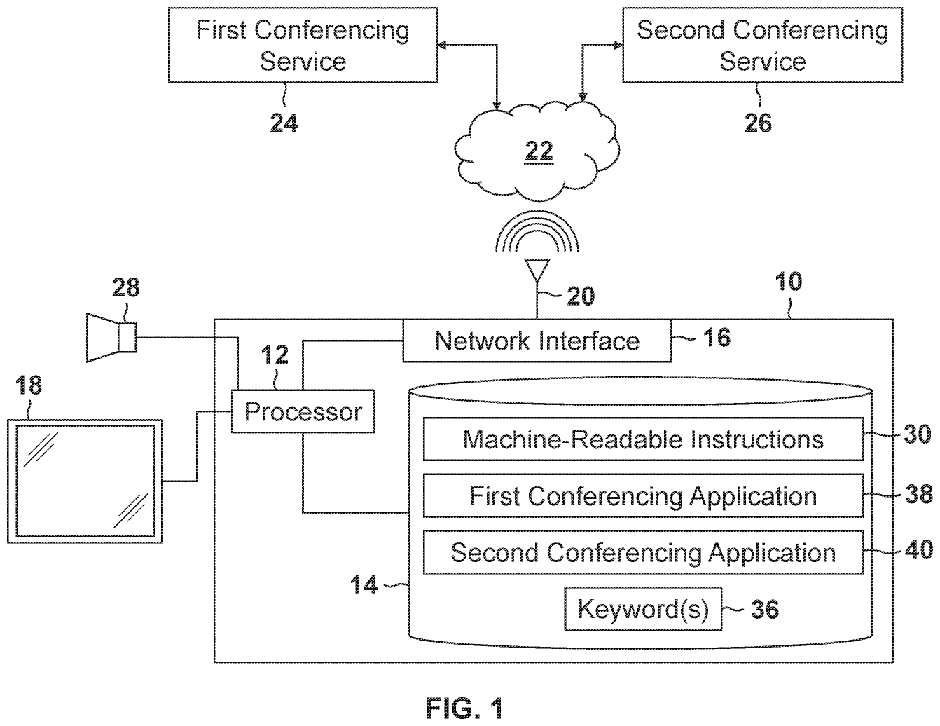

Referring now to FIG. 1, an electronic device 10 for monitoring voice conference sessions executed thereon according to some examples is shown. The electronic device 10 may comprise any of the example electronic devices mentioned above. However, in some examples, the electronic device 10 may comprise a computer, such as a laptop computer or desktop computer. Electronic device 10 includes a processor 12, a memory 14, and a network interface 16.

The processor 12 may comprise any suitable processing device, such as a microprocessor or central processing unit (CPU). The processor 12 executes machine-readable instructions (e.g. machine-readable instructions 30) stored on memory 14, thereby causing the processor 12 (and, more generally, electronic device 10) to perform some or all of the actions attributed herein to the processor 12 (and, more generally, to electronic device 10). The memory 14 (e.g., a non-transitory machine-readable medium) may comprise volatile storage (e.g., random access memory (RAM)), non-volatile storage (e.g., flash storage, etc.), or combinations of both volatile and non-volatile storage. Data read or written by the processor 12 when executing machine-readable instructions can also be stored on memory 14.

The processor 12 may comprise one processing device or a plurality of processing devices that are distributed within electronic device 10. Likewise, the memory 14 may comprise one memory device or a plurality of memory devices that are distributed within the electronic device 10.

The electronic device 10 may communicate with other devices via a network 22, such as, for instance, the Internet, a telecommunications network, etc. For instance, the network interface 16 may be coupled to an antenna 20 that communicates wirelessly with network 22 (or, more specifically, a node or gateway of network 22). In some examples, network interface 16 may communicate with network 22 via a wired connection (e.g., via Ethernet cable).

The electronic device 10 also includes (or is coupled to) a display 18. Accordingly, processor 12 may cause images to be presented on display 18 during operation. Display 18 may comprise any suitable display device, such as, for instance, a liquid crystal display (LCD), an organic light emitting diode (OLED) display, a micro-LED display, a plasma display, etc.

In addition, electronic device 10 also includes (or is coupled to) a speaker 28. In some examples, the speaker 28 may comprise a speaker (or collection of speakers) for emitting audible sound waves into an environment (e.g., such as into an environment immediately surrounding the electronic device 10). In some examples, the speaker 28 may be incorporated within a headset that is wearable by the user (not shown).

During operation, electronic device 10 may execute one or a plurality of voice conferencing sessions. More specifically, in some examples, the electronic device 10 may receive data for a first voice conferencing session from a first conferencing service 24 and may receive data for a second voice conferencing session from a second conferencing service 26 via the network 22. The first conferencing service 24 may or may not be different from the second conferencing service 26.

The first voice conferencing session is executed on electronic device 10 via a first conferencing application 38, and the second voice conferencing session is executed on electronic device 10 via a second conferencing application 40. The first conferencing application 38 may comprise machine-readable instructions for processing data associated with the first voice conferencing session, and the second conferencing application 40 may comprise machine-readable instructions for processing data associated with the second voice conferencing session. As shown in FIG. 1, the machine-readable instructions for both the first conferencing application 38 and the second conferencing application 40 may be stored in memory 14.

Referring specifically to the first voice conferencing session, data is provided to the electronic device 10 from the first conferencing service 24 via network 22, antenna 20 and network interface 16. The processor 12 may process the incoming data according to the machine-readable instructions of the first conferencing application 38 and output corresponding audio and/or visual signals associated with the first voice conferencing session to the speaker 28 and display 18, respectively. Conversely, audio and/or visual inputs from the user to the first voice conferencing session (e.g., such as visual inputs captured by a camera and audio inputs captured by a microphone) may be processed by the processor 12 according to the machine-readable instructions of the first conferencing application 38 and may be communicated to the first conferencing service 24 via network interface 16, antenna 20, and network 22.

Referring specifically to the second voice conferencing session, data is provided to the electronic device 10 from the second conferencing service 26 via network 22, antenna 20, and network interface 16. The processor 12 may process the incoming data according to the machine-readable instructions of the second conferencing application 40 and output corresponding audio and/or visual signals associated with the second voice conferencing session to the speaker 28 and display 18, respectively. Conversely, audio and/or visual inputs from the user to the second voice conferencing session may be processed by the processor 12 according to the machine-readable instructions of the second conferencing application 40 and may be communicated to the second conferencing service 26 via network interface 16, antenna 20, and network 22.

Referring still to FIG. 1, during execution of the first voice conferencing session and the second voice conferencing session, processor 12 may also execute machine-readable instructions 30 for monitoring the content of the first voice conferencing session and the second voice conferencing session to determine whether the user is being cued (e.g., via question, subject matter, etc.) to provide input thereto. In some examples, the machine-readable instructions 30 may comprise a daemon that is executed by the processor 12 during operation of electronic device 10 (and particularly during execution of a voice conferencing session).

More particularly, machine-readable instructions 30 may cause processor 12 to determine the process identifiers (IDs) assigned by electronic device 10 (particularly processor 12) to the processes associated with the first voice conferencing session and the second voice conferencing session (e.g., such as the processes generated by execution of the machine-readable instructions of the first conferencing application 38 and the second conferencing application 40 as described above). In some examples, the process IDs may comprise numeric codes or other unique identifiers that are assigned by the electronic device 10 to distinguish multiple simultaneous processes being executed on processor 12. In some examples, the process IDs may be determined by analyzing some or all of the processes being executed by the electronic device 10 to determine which of these processes may be associated with the first conferencing application 38 and/or the second conferencing application 40.

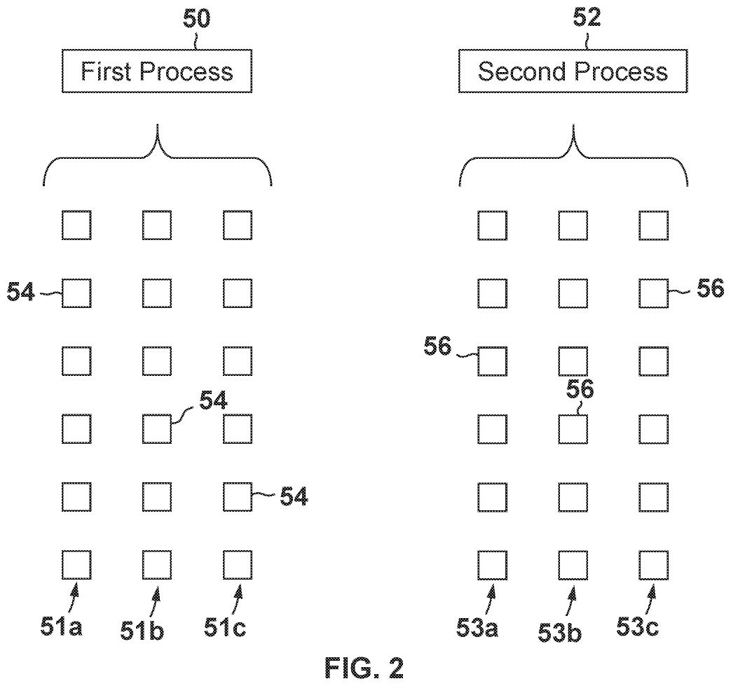

Once the process IDs of the first voice conferencing session and second voice conferencing session are identified, machine-readable instructions 30 further cause the processor 12 to determine the thread IDs of the thread(s) associated with the identified process IDs that comprise the audio data for the first voice conferencing session and the second voice conferencing session. For instance, reference is now made to FIG. 2, in which a pair of processes that may be executed on the electronic device 10 (e.g., FIG. 1) to conduct the first voice conferencing session and the second voice conferencing session are shown schematically. In particular, FIG. 2 depicts a first process 50 that is executed on the processor 12 (e.g., FIG. 1) to conduct the first voice conferencing session, and a second process 52 that is executed on the processor 12 (e.g., FIG. 1) to conduct the second voice conferencing session. The first process 50 may include a plurality of threads 51a, 51b, 51c that each comprise a corresponding stream of data packets 54 associated with the first voice conferencing session, and the second process 52 may include a plurality of threads 53a, 53b, 53c that each comprise a corresponding stream of data packets 56 associated with the second voice conferencing session. Each thread 51a, 51b, 51c may provide data packets 54 for a different aspect of the first voice conferencing session, and each thread 53a, 53b, 53c may provide data packets 56 for a different aspect of the second voice conferencing session. For instance, taking the first process 50 as an example, data packets 54 for some of the threads 51a, 51b, 51c may comprise audio data for the first voice conferencing session, while data packets 54 for others of the threads 51a, 51b, 51c may comprise visual data for the first voice conferencing session.

During operation, once the process ID of the first process 50 and the process ID of the second process 52 are identified as previously described, the processor 12 (e.g., FIG. 1) may sample the data packets 54 for each of the threads 51a, 51b, 51c of the first process 50 to determine which thread 51a, 51b, 51c comprises the audio data of the first voice conferencing session, and may sample the data packets 56 for each of the threads 53a, 53b, 53c of the second process 52 to determine which thread 53a, 53b, 53c comprises the audio data of the second voice conferencing session. For example, the processor 12 may determine which of the threads 51a, 51b, 51c and which of the threads 53a, 53b, 53c comprise audio data based on an analysis of the payloads of the corresponding data packets 54, 56. Once the processor 12 determines which of the threads 51a, 51b, 51c comprises audio data of the first voice conferencing session and which of the threads 53a, 53b, 53c comprises audio data of the second voice conferencing session, the processor 12 may identify the thread IDs associated with the corresponding ones of the threads 51a, 51b, 51c and the threads 53a, 53b, 53c as being associated with audio data of the first voice conferencing session and the second voice conferencing session, respectively. As was explained above for the process IDs (e.g., of the processes 50, 52), in some examples thread IDs may comprise numeric codes or other unique identifiers that are assigned by the electronic device 10 to distinguish multiple simultaneous threads being executed on processor 12. In some examples, the thread IDs may be related or traceable (e.g., via common numeric codes or other suitable technique) to the processes (e.g., processes 50, 52) with which the particular threads are associated.

Referring again to FIG. 1, next the processor 12 may, as directed by machine-readable instructions 30, monitor the audio data of the first voice conferencing session and second voice conferencing session using the determined process IDs and thread IDs. For instance, in some examples the processor 12 may compare the audio data to one or a plurality of keywords 36 that may be stored in memory 14. In particular, the processor 12 may sample the audio data using the previously determined process IDs and thread IDs associated with the first voice conferencing session and the second voice conferencing session and transcribe the audio data into text via a speech to text application or any other suitable technique, system, or method. Thereafter, the text may be compared to the keyword(s) 36 to identify any matches.

The keyword(s) 36 may be selected (e.g., by the user and/or the electronic device 10) to indicate when the user is being cued for providing input to the first voice conferencing session or the second voice conferencing session. In some examples, the keyword(s) 36 may comprise the user's name (or a part thereof), a name of the user's supervisor or co-worker, a word associated with a particular subject-matter, a department name, etc.

If a match is detected between the audio data of the first voice conferencing session or the second voice conferencing session and the keyword(s) 36, the processor 12 may then generate a notification that may be output to the display 18 and/or the speaker 28 to cue the user to provide input to the first voice conferencing session or the second voice conferencing session. For instance, the notification may comprise a pop-up window on the display 18 that may obstruct or minimize other content being presented thereon. In some examples, the pop-up window may comprise a user-interface for the first voice conferencing session or the second voice conferencing session. In some examples, the notification may comprise an audio feed from the corresponding voice conferencing session (e.g., the first voice conferencing session or the second voice conferencing session) to the speaker 28. However, any suitable method of notifying the user that a response is needed or appropriate in one of the voice conferencing sessions may be used in other examples.

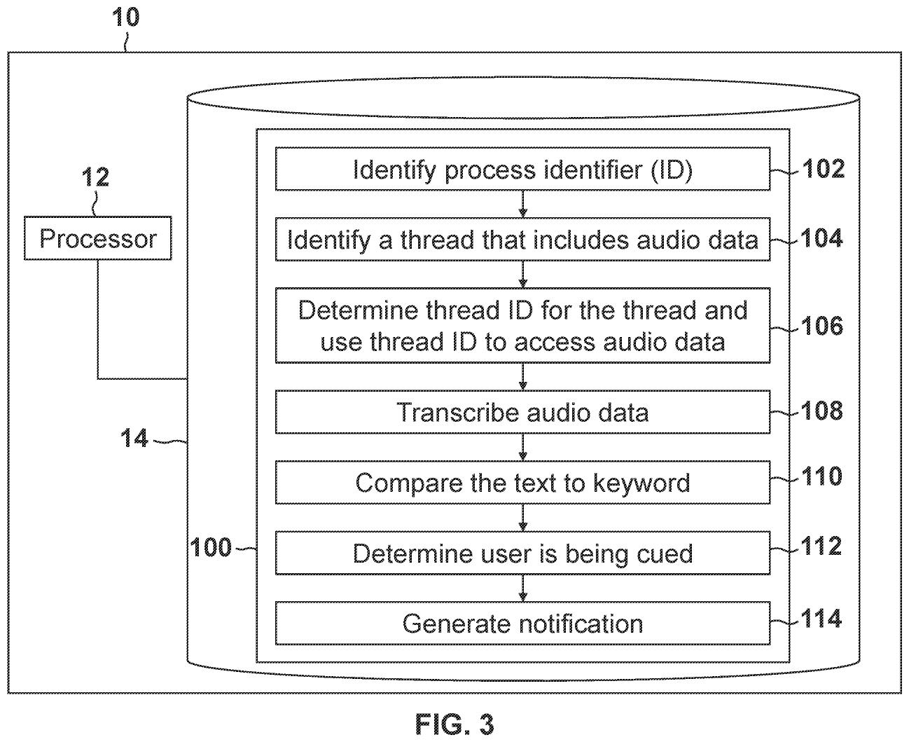

Referring now to FIG. 3, an example of the machine-readable instructions (e.g., FIG. 1) are shown as machine-readable instructions 100. Machine-readable instructions 100 may be executed by processor 12 to monitor voice conferencing sessions being executed on electronic device 10 as described above. In describing the features of machine-readable instructions 100 in FIG. 3, continuing reference is made to the features shown in FIGS. 1 and 2.

Machine-readable instructions 100 comprise identifying a process ID assigned by the electronic device 10 to a voice conferencing session executed on the electronic device 10 at block 102. In some examples, the voice conferencing session may comprise the first voice conferencing session or the second voice conferencing session described above. In addition, identifying the process ID assigned to the voice conferencing session may comprise analyzing the processes executed on the electronic device 10 to determine which process(es) are associated with a voice conferencing application as described above.

In addition, machine-readable instructions 100 include identifying a thread associated with the process ID that includes audio data for the voice conferencing session at block 104. For instance, as described above for the processes 50, 52 shown in FIG. 2, the processor 12 may sample data packets (e.g., data packets 54, 56 in FIG. 2) associated with the process ID to determine, based on the payload of the sampled data packets, which thread(s) associated with the process ID includes audio data for the voice conferencing session. Accordingly, at block 106, machine-readable instructions 100 may comprise determining that the thread ID for the thread that includes audio data and using the thread ID to access the audio data.

Further, machine-readable instructions 100 may comprise transcribing the audio data into text at block 108 and comparing the text to a keyword stored in the memory 14 at block 110. For instance, as described above, the processor 12 may transcribe the audio data into text via a suitable method, system, or application, and then compare the transcribed text to stored keyword(s) to determine if there is a match.

Still further, machine-readable instructions 100 may comprise, at block 112, determining that a user of the electronic device is being cued in the voice conferencing session based on the comparison at block 110. Accordingly, at block 114, machine-readable instructions 100 may comprise generating a notification for the user that input is requested in the voice conferencing session. The notification may comprise a visual and/or audio notification that may alert the user to the need for input to the voice conferencing session in the manner described above.

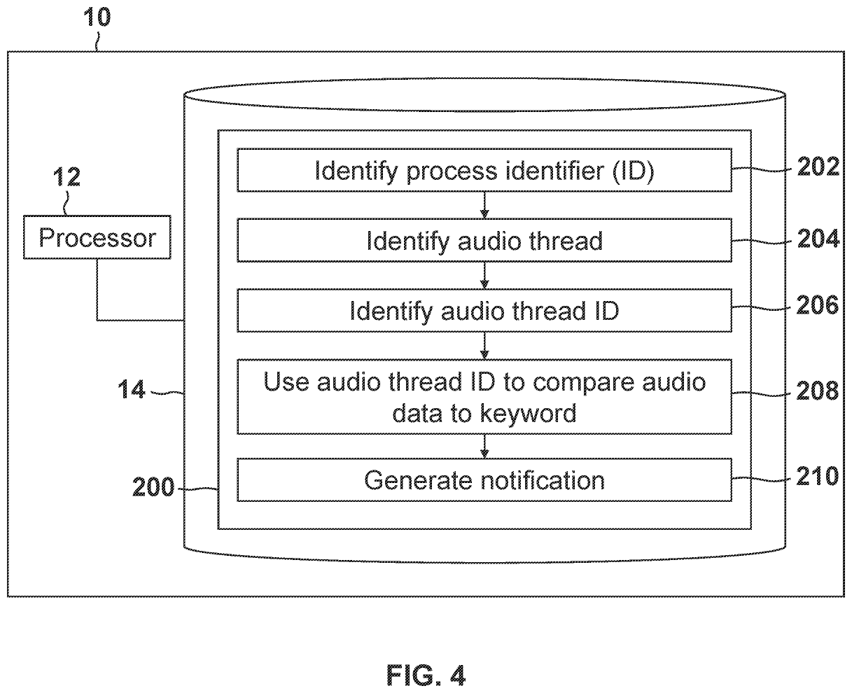

Referring now to FIG. 4, an example of the machine-readable instructions (e.g., FIG. 1) are shown as machine-readable instructions 200. Machine-readable instructions 200 may be executed by processor 12 to monitor voice conferencing sessions being executed on electronic device 10 as described above. In describing the features of machine-readable instructions 200 in FIG. 4, continuing reference is made to the features shown in FIGS. 1 and 2.

Machine-readable instructions 200 may include identifying a process ID assigned to a voice conferencing session being executed on the electronic device at block 202. In some examples, the voice conferencing session may comprise the first voice conferencing session or the second voice conferencing session described above. In addition, identifying the process ID at block 202 may be carried out in the manner described above for block 102 of machine-readable instructions 100 (e.g., FIG. 3).

In addition, machine-readable instructions 200 include identifying an audio thread using the process ID at block 204, and identifying an audio thread ID of the audio thread at block 206. For instance, in some examples, blocks 204 and 206 may be carried out in the manner described above for blocks 104 and 106 of machine-readable instructions 100 (e.g., FIG. 3).

Further, machine-readable instructions 200 include using the audio thread ID to compare the audio data to a keyword to identify a match at block 208. For instance, in some examples, block 208 may be carried out in the manner described above for blocks 108 and 110 of machine-readable instructions 100 (e.g., FIG. 3).

Still further, machine-readable instructions 200 include, at block 210, generating a notification for a user of the electronic device 10 in response to the match from block 208. The notification may comprise a visual and/or audio notification that may alert the user to the need for input to the voice conferencing session in the manner described above.

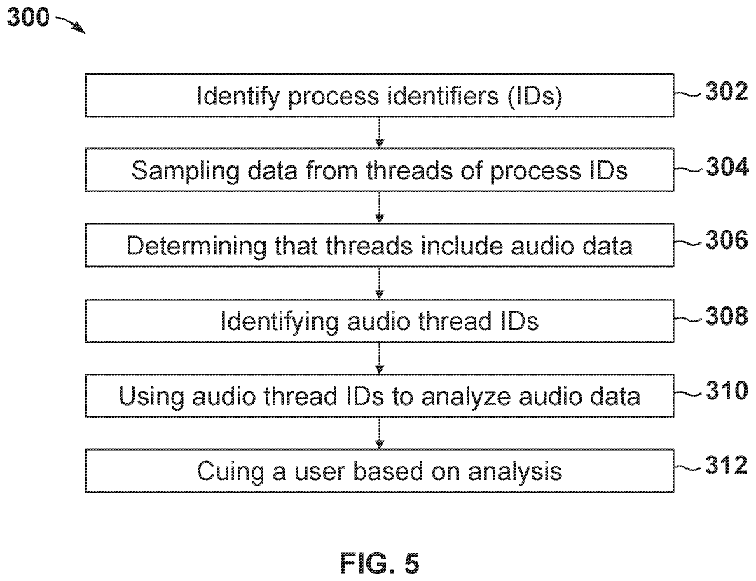

Referring now to FIG. 5, a method 300 of monitoring voice conferencing sessions being executed on an electronic device (e.g., electronic device 10) is shown. In some examples, some or all of method 300 may be performed by a processor executing machine-readable instructions (e.g., such as machine-readable instructions 30 shown in FIG. 1).

Method 300 includes identifying process IDs assigned by an electronic device for multiple voice conferencing sessions executed simultaneously on the electronic device at block 302. For instance, as described above for the electronic device 10 of FIG. 1, the processor 12 may analyze the processes being executed on the electronic device 10 to determine which of these processes may be associated with a voice conferencing application. As a result, the processor 12 may then identify the process ID for any such processes as being assigned to the voice conferencing sessions executed on the electronic device 10.

In addition, method 300 includes sampling data from threads associated with the process IDs at block 304, determining that threads include audio data for the voice conferencing sessions based on the sampling at block 306, and identifying audio thread IDs for the threads at block 308. For instance, as was described above for electronic device 10 and shown in FIGS. 1 and 2, the processor 12 may sample data packets 54, 56 of the threads 51a, 51b, 51c, and threads 53a, 53b, 53c to determine, based on analysis of the payload of the data packets 54, 56, which threads of the previously identified process IDs comprises audio data. Thereafter, the processor may identify the thread IDs associated with the audio data carrying threads 51a, 51b, 51c, 53a, 53b, 53c as the thread IDs associated with the audio data of the voice conferencing sessions being executed on the electronic device 10.

Further, method 300 includes using the audio thread IDs to analyze the audio data for each of the threads at block 310. For instance, as described above for electronic device 10, the processor 12 may analyze audio data of the identified audio thread IDs by transcribing the audio data into text via a suitable method, system, or application, and then comparing the transcribed text to stored keyword(s) to determine if there is a match.

Still further, method 300 includes cuing a user of the electronic device to provide input to one of the voice conferencing sessions at block 312 based on the analysis at block 310. In some examples, the cuing at block 312 may comprise generating a notification such as is described above for electronic device 10. However, any suitable cuing method may be utilized to alert the user that input is requested and/or appropriate in one of the voice conferencing sessions at block 312.

Example systems and methods have been described herein for monitoring the content of one (or a plurality of) voice conferencing sessions being executed on an electronic device, and for cuing the user when a response is requested or appropriate. Thus, through use of the examples systems and methods described herein, a user may more effectively multi-task during a voice conference.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

As used herein, including in the claims, the word “or” is used in an inclusive manner. For example, “A or B” means any of the following: “A” alone, “B” alone, or both “A” and “B.”

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory machine-readable medium storing instructions, which, when executed by a processor of an electronic device, cause the processor to:
identify a process identifier (ID) assigned to a voice conferencing session executed on the electronic device;
identify an audio thread using the process ID, the audio thread including audio data for the voice conferencing session;
identify an audio thread ID of the audio thread;
use the audio thread ID to compare the audio data to a keyword to identify a match; and
generate a notification for a user of the electronic device in response to the match.

2. The non-transitory machine-readable medium of claim 1, wherein the instructions, when executed by the processor, cause the processor to:
transcribe the audio data into text; and
compare the text to the keyword to identify the match.

3. The non-transitory machine-readable medium of claim 1, wherein the instructions, when executed by the processor, cause the processor to:
sample data from a plurality of threads associated with the process ID;
determine that a thread of the plurality of threads comprises the audio data based on the sampling; and
identify the thread of the plurality of threads as the audio thread based on the determination.

4. The non-transitory machine-readable medium of claim 1, wherein the notification comprises a visual notification presented on a display.

5. The non-transitory machine-readable medium of claim 1, wherein the keyword comprises a name of the user.

6. A method, comprising:
identifying process identifiers (IDs) assigned by an electronic device for multiple voice conferencing sessions being executed simultaneously on the electronic device;
sampling data from threads associated with the process IDs;
determining that the threads include audio data for the voice conferencing sessions based on the sampling;
identifying audio thread IDs for the threads;
using the audio thread IDs to analyze the audio data for each of the threads; and
cuing a user of the electronic device to provide input to one of the voice conferencing sessions based on the analysis.

7. The method of claim 6, wherein a first of the process IDs is associated with a first voice conferencing application, and a second of the process IDs is associated with a second voice conferencing application that is different from the first voice conferencing application.

8. The method of claim 6, wherein using the audio thread IDs to analyze the audio data for each of the threads comprises:
transcribing the audio data for each of the threads into text; and
comparing the text to a keyword to identify a match.

9. The method of claim 8, wherein the keyword comprises a name of the user.

10. The method of claim 6, wherein cuing the user comprises visually cuing the user on a display.

11. An electronic device, comprising:
a memory; and
a processor communicatively coupled to the memory, wherein the processor is to:
identify a process identifier (ID) assigned by the electronic device to a voice conferencing session executed on the electronic device;
identify a thread associated with the process ID that includes audio data for the voice conferencing session;
determine an audio thread ID for the thread and use the audio thread ID to access the audio data;
transcribe the audio data into text;
compare the text to a keyword stored in the memory;
determine that a user of the electronic device is being cued in the voice conferencing session based on the comparison; and
generate a notification for the user that input is requested in the voice conferencing session.

12. The electronic device of claim 11, wherein the processor is to identify the thread associated with the process ID that includes the audio data for the voice conferencing session by:
sampling data from a plurality of threads associated with the process ID; and
detecting the audio data in the thread based on the sampling.

13. The electronic device of claim 11, wherein the keyword comprises a name of the user.

14. The electronic device of claim 11, comprising a display coupled to the processor, wherein the notification comprises a visual notification on the display.

15. The electronic device of claim 11, comprising a speaker coupled to the processor, wherein the notification comprises an audio feed of the voice conferencing session that is emitted from the speaker.
